(19) United States
(12) Patent Application Publication
(10) Pub. No.: US 2025/0099212 A1
(43) Pub. Date: Mar. 27, 2025

(54) METHOD FOR GENERATING THREE-DIMENSIONAL DIGITAL DENTAL MODEL

(71) Applicant: SHANGHAI EA MEDICAL INSTRUMENTS COMPANY LIMITED, Shanghai (CN)

(72) Inventors: Yuan REN, Shanghai (CN); Mingzheng WANG, Shanghai (CN); Yang Feng, Shanghai (CN); Deming Qiao, Shanghai (CN)

(21) Appl. No.: 18/832,878

(22) PCT Filed: Jan. 20, 2023
(86) PCT No.: PCT/CN2023/073409

§ 371 Date: Jul. 24, 2024

(30) Foreign Application Priority Data
Jan. 25, 2022 (CN) 202210089331.1
Jan. 25, 2022 (CN) 202210089332.6
Feb. 11, 2022 (CN) 202210128253.1

(51) Int. Cl. A61C 13/34; A61C 7/00; A61C 7/08; G06T 17/00; G06T 19/20

(52) U.S. Cl. CPC A61C 13/34; A61C 7/002; G06T 17/00; G06T 19/20; A61C 7/08; G06T 2210/41; G06T 2219/2021

(57) ABSTRACT

One aspect of the present application provides a computer-implemented method for generating a 3D digital model of gingiva, comprising: obtaining a 3D digital model of gingiva in a first state; and performing deformation process on the 3D digital model of the gingiva in the first state based on its deformation control points and deformation control points of a 3D digital model of crowns in a second state, to obtain a 3D digital model of the gingiva in the second state, wherein corresponding deformation control points of 3D digital models of the crowns and the gingiva in the same state coincide.

### FIELD OF THE APPLICATION

The present application generally relates to a method for generating a 3D digital model of a jaw.

### BACKGROUND

Shell-shaped tooth repositioners made of polymer materials become more and more popular due to their advantages on aesthetic appearance, convenience and ease to clean.

A method of making a shell-shaped tooth repositioner of a repositioning step is forming the shell-shaped repositioner by pressing a heated and softened polymer film material on a model of a jaw (including crowns and a part of a gingiva), wherein the crown part of the model matches a target tooth arrangement of the repositioning step.

In a conventional solution, a corresponding 3D digital model is used to control an apparatus (e.g., a stereolithography apparatus) to make the model of jaw. As for a series of successive shell-shaped tooth repositioners, the gingiva parts of a corresponding series of successive 3D digital models of jaws are consistent, i.e., the gingiva parts are the patient's gingiva in the initial state (the state before the orthodontic treatment).

During the orthodontic treatment, the gingiva deforms as the teeth move. Therefore, the gingiva on these jaw models is inconsistent with the real gingiva. This might cause shell-shaped tooth repositioners fabricated in this way being non-fit or over-fit (causing pressure on the gingiva by a shell-shaped tooth repositioner) some regions of the gingiva, particularly the gingiva between two adjacent teeth or the gingiva where a tooth is missing.

In addition, before an orthodontic treatment, a dentist needs to show the patient the change of the jaw during the orthodontic treatment. However, in conventional solutions, the gingiva of the series of successive jaw 3D digital models remains unchanged and consistent with the gingiva in the initial state so that the dentist cannot show the change to the gingiva caused by the orthodontic treatment.

For the above reasons, it is necessary to provide a new method for generating a jaw 3D digital model, to generate a jaw 3D digital model of which the gingiva is closer to the actual condition.

### SUMMARY

In one aspect, the present application provides a computer-implemented method for generating a 3D digital model of gingiva, the method includes: obtaining a 3D digital model of gingiva of a jaw in a first state; and performing a deformation process on the 3D digital model of the gingiva in the first state based on deformation control points of the 3D digital model of the gingiva in the first state and deformation control points of a 3D digital model of crowns of a jaw in a second state, to obtain a 3D digital model of the gingiva in the second state, wherein corresponding deformation control points of the 3D digital model of the crowns and the 3D digital model of the gingiva in a same state coincide with each other.

In some embodiments, in the deformation process, the deformation control points of the 3D digital model of the crowns in the second state may be taken as new positions of corresponding deformation control points of the 3D digital model of the gingiva in the first state, a deformation equation may be established based on this, and coordinates of vertices of the 3D digital model of the gingiva in the second state are calculated.

In some embodiments, the deformation control points of the 3D digital model of the gingiva in the first state may comprise deformation control points on boundaries of between the gingiva and the crowns, the deformation control points of the 3D digital model of the crowns may comprise deformation control points on the boundaries of the crowns, and the deformation control points on the boundaries between the gingiva and the crowns of the 3D digital model of the gingiva in the first state may correspond to those on the boundaries of the crowns of the 3D digital model of the crowns respectively.

In some embodiments, the deformation control points of the 3D digital model of the gingiva may further comprise deformation control points on an edge line of a bottom surface, and the deformation control points on the edge line of the bottom surface may remain stationary in the deformation process.

In some embodiments, the deformation process may be based on a TPS deformation method.

In some embodiments, the first state may be an initial state.

In some embodiments, the deformation control points may be obtained by sampling on a 3D digital model of a jaw in the initial state.

In some embodiment, the numbers of the deformation control points may be predetermined and they may be obtained by sampling evenly.

In some embodiment, the 3D digital model of the jaw in the initial state may be obtained by scanning one of the following: a patient's jaw, an impression of the patient's jaw and a physical model of the patient's jaw.

In some embodiment, the 3D digital model of the gingiva in the first state may comprise a real gingiva part and a base, wherein the real gingiva part is joined with the crowns and located on the base.

In some embodiment, the real gingiva part may be a gingiva part within a predetermined distance from a gingival line.

In some embodiment, the first state may be the initial state, and the method for generating a 3D digital model of gingiva may further comprise: obtaining a plurality of 3D digital models representing the crowns in successive states respectively; and repeating the above operation to generate a plurality of 3D digital models representing the gingiva in the successive states respectively, each of which may be generated based on the 3D digital model of the gingiva in the first state and a corresponding one among the plurality of the 3D digital models of the crowns.

In another aspect, the present application provides a method for generating a 3D digital model of a jaw, comprising: combining the 3D digital model of the gingiva in the second state generated by the above method and the 3D digital model of the crowns in the second state, to obtain a 3D digital model of jaw in the second state.

In a further aspect, the present application provides a method for making a shell-shaped tooth repositioner, comprising: using the 3D digital model of the jaw in the second state generated by the above method to control an apparatus to make a shell-shaped tooth repositioner.

In a further aspect, the present application provides a computer system for generating a 3D digital model of gingiva, the system comprising a storage device and a processor, wherein the storage device stores a computer program, when the computer program is executed, it will cause the processor to perform the method for generating a 3D digital model of gingiva.

In a further aspect, the present application provides a computer-implemented method for generating a 3D digital model of gingiva, comprising: obtaining a 3D digital model of a gingiva template; obtaining a 3D digital model of crowns of a jaw; and performing 3D deformation process on the 3D digital model of the gingiva template based on deformation control points on the 3D digital model of the gingiva template and deformation control points on the 3D digital model of the crowns, to obtain a 3D digital model of gingiva that matches the 3D digital model of the crowns.

In some embodiments, in the deformation process, the deformation control points of the 3D digital model of the crowns may be taken as new positions of corresponding deformation control points of the 3D digital model of the gingiva template, a 3D deformation equation may be established based on this, and coordinates of vertices of the 3D digital model of the gingiva may be calculated.

In some embodiments, the deformation control points of the 3D digital model of the gingiva template may comprise deformation control points on boundaries of the crowns, the deformation control points of the 3D digital model of the crowns may comprise deformation control points on the boundaries of the crowns, and the deformation control points on the boundaries of the crowns of the 3D digital model of the crowns may correspond to those on the boundaries of the crowns of the 3D digital model of the gingiva template respectively.

In some embodiments, the deformation control points of the 3D digital model of the gingiva template may further comprise deformation control points between every two neighboring tooth positions, the deformation control points of the 3D digital model of the crowns may further comprise deformation control points between every two neighboring crowns, and the deformation control points between neighboring crowns of the 3D digital model of the crowns may correspond to those between neighboring tooth positions of the 3D digital model of the gingiva template respectively.

In some embodiments, the deformation control points of the 3D digital model of the gingiva template may further comprise deformation control points on an edge line of a bottom surface thereof, and the deformation control points on the edge line of the bottom surface of the 3D digital model of the gingiva template may remain stationary in the 3D deformation process.

In some embodiments, the 3D deformation process may be based on a TPS deformation method.

In some embodiments, the method for generating a 3D digital model of gingiva may further comprise: adjusting a number of tooth positions of the 3D digital model of the gingiva template according to the 3D digital model of the crowns, the 3D deformation process is based on the 3D digital model of the gingiva template after adjustment of the number of tooth positions.

In some embodiments, the method for generating a 3D digital model of gingiva may further comprise: scaling the 3D digital model of the gingiva template according to the 3D digital model of the crowns so that the contour of the 3D digital model of the gingiva template substantially coincides with that of the 3D digital model of the crowns, and the 3D deformation process is based on the scaled 3D digital model of the gingiva template.

In some embodiments, the method for generating a 3D digital model of gingiva may further comprise: adjusting the arch shape of the scaled 3D digital model of the gingiva template according to the 3D digital model of the crowns.

In some embodiments, the adjustment of the arch shape of the scaled 3D digital model of the gingiva template may comprise: fitting a first spline curve based on centers of the boundaries of crowns of the 3D digital model of the crowns, and sampling N deformation control points evenly thereon; fitting a second spline curve based on centers of the tooth positions of the 3D digital model of the gingiva template, and sampling N deformation control points evenly thereon; establishing a deformation equation based on deformation anchor points on the first spline curve and deformation anchor points on the second spline curve, and performing 2D deformation process on the 3D digital model of the gingiva template and its deformation control points.

In some embodiments, the 2D deformation process may be based on a TPS deformation method.

In some embodiments, the method for generating a 3D digital model of gingiva may further comprise: performing 2D scaling on the two ends of the 3D digital model of the gingiva template whose arch shape is adjusted.

In some embodiments, the method for generating a 3D digital model of gingiva may further comprise: based on mapping of deformation control points of the 3D digital model of the gingiva on a texture map, calculating mapping of all vertices of the 3D digital model of the gingiva on the texture map using a Harmonic Map algorithm; and performing a texture mapping operation on the 3D digital model of the gingiva based on the calculated mapping.

In some embodiments, the 3D digital model of the crowns may be obtained by scanning one of the following: a patient's jaw, an impression of the patient's jaw and a physical model of the patient's jaw.

In some embodiments, the method for generating a 3D digital model of gingiva may further comprise: obtaining a plurality of 3D digital models of the crowns respectively representing a plurality of successive tooth arrangements; and performing deformation process on the gingiva 3D digital model template according to the plurality of 3D digital models of the crowns, respectively, to generate a plurality of successive 3D digital models of the gingiva.

In a further aspect, the present application provides a method for generating a 3D digital model of a jaw, the method comprises: combining the 3D digital model of the gingiva with the 3D digital model of the crowns to obtain a 3D digital model a jaw.

In a further aspect, the present application provides a method for making a shell-shaped tooth repositioner, the method comprises: using the 3D digital model of the jaw to control an apparatus to make a shell-shaped tooth repositioner.

In a further aspect, the present application provides a computer system for generating a 3D digital model of gingiva, the system comprises a storage device and a processor, wherein the storage device stores a computer program which when executed will cause the processor to perform the method for generating a 3D digital model of gingiva.

In a further aspect, the present application provides a computer-implemented method for generating a 3D digital model of a tooth, comprising: obtaining a 3D digital model of a crown; obtaining a 3D digital model of a root template; performing deformation process on the 3D digital model of the root template based on N deformation control points on a boundary of the 3D digital model of the root template and corresponding N deformation control points on a boundary of the 3D digital model of the crown, to obtain a 3D digital model of a root that matches the 3D digital model of the crown; and stitching the boundary of the 3D digital model of the crown with the boundary of the 3D digital model of the root to obtain a complete 3D digital model of a tooth, where the N is a natural number.

In some embodiments, the 3D digital model of the root template may be obtained by averaging 3D digital models of a plurality of real roots of a corresponding tooth number.

In some embodiments, the computer-implemented method for generating a 3D digital model of a tooth may further comprise: before the deformation process, aligning the 3D digital model the root template with the 3D digital model of the crown by translating and/or rotating so that they have the same mesial-distal direction and parallel long axes.

In some embodiments, the computer-implemented method for generating a 3D digital model of tooth may further comprise: after the alignment, scaling the 3D digital model of the root template such that its size substantially matches that of the 3D digital model of the crown.

In some embodiments, the computer-implemented method for generating a 3D digital model of a tooth may further comprise: performing geometry harmonic on a root region of the 3D digital model of the tooth which root region joints the crown, to make the joint of the crown and the root more natural.

In some embodiments, the deformation process may comprise: taking the deformation control points of the 3D digital model of the crown as new positions of corresponding deformation control points of the 3D digital model the root template, establishing a 3D deformation equation based on this, and calculating new positions of vertices of the 3D digital model of the root template.

In some embodiments, the 3D deformation process may be based on a TPS deformation method.

In some embodiments, the 3D digital model of the crown may be obtained by scanning one of the following: a patient's jaw, an impression of the patient's jaw and a physical model of the patient's jaw.

In some embodiments, the N control points on the boundary of the 3D digital model of the crown may be obtained by sampling evenly, and the N control points on the boundary of the 3D digital model of the root template may be obtained by sampling evenly.

In some embodiments, the computer-implemented method for generating a 3D digital model of a tooth may further comprise: generating 3D digital models of two neighboring teeth using the above method; detecting whether roots of the 3D digital models of the two neighboring teeth collide each other, and if YES, classifying the collision based on a predetermined threshold and a collision depth into a moderate collision or a deep collision; if the collision is the moderate collision, finding all collision points and their neighboring points, moving each of these points in a direction opposite to its normal direction by a distance determined according to the collision depth, and performing a harmonic shape and smoothing operation on all the involved points; if the collision is a deep collision, determining points to be moved on the two roots according to the heights of the deepest collision points, moving these points to be moved along a line that passes the two deepest collision points by a distance determined according to a maximum collision depth, and performing a harmonic shape operation on other points on the two roots.

In a further aspect, the present application provides a computer system for generating a 3D digital model of a tooth, the system comprises a storage device and a processor, wherein the storage device stores a computer program which when executed will cause the processor to perform the method for generating the tooth 3D digital model.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the scope of the present application. Unless otherwise specified, the figures are not necessarily drawn to scale, and similar reference numbers therein denote similar components.

FIG. 1 schematically illustrates a flow chart of a method for generating a 3D digital model of a jaw according to one embodiment of the present application;

FIG. 2A illustrates gingiva part obtained by removing crown part from a 3D digital model of jaw in an initial state obtained by scanning in one example, shown in one interface of a computer program for generating a 3D digital model of jaw;

FIG. 2B illustrates a remaining part after an unnecessary part is removed from the 3D digital model of gingiva shown in FIG. 2A, shown in one interface of the computer program;

FIG. 3A schematically illustrates projected points and a first curve obtained by fitting based on these projected points in one example;

FIG. 3B schematically illustrates a complete contour line of the bottom surface of a base in one example;

FIG. 4A illustrates a point could for Poisson reconstruction of a 3D digital model of gingiva in a first state in one example, shown in one interface of the computer program;

FIG. 4B illustrates a 3D digital model of gingiva in the first state obtained by Poisson construction based on the point cloud shown in FIG. 4A, shown in one interface of the computer program;

FIG. 5 illustrates a 3D digital model of the jaw in a second state which is obtained by combination, shown in one interface of the computer program;

FIG. 6 schematically illustrates a flow chart of a method for generating a 3D digital model of a jaw according to another embodiment of the present application;

FIG. 7 illustrates a 3D digital model of a gingiva template in one example, shown in one interface of the computer program for generating a 3D digital model of a jaw;

FIG. 8 illustrates partial deformation control points on a 3D digital model of a gingiva template in one example, shown in one interface of the computer program;

FIG. 9 illustrates mapping of partial deformation control points on a 3D digital model of a gingiva template (on the left side) to a texture map (on the right side) in one example, shown in one interface of the computer program;

FIG. 10A illustrates a 3D digital model gingiva template in one example, shown in one interface of the computer program;

FIG. 10B illustrates the 3D digital model of the gingiva template shown in FIG. 10A of which one tooth position is removed from both ends, shown in one interface of the computer program;

FIG. 11A illustrates a 3D digital model of crowns, a first spline curve and its deformation anchor points in one example, shown in one interface of the computer program;

FIG. 11B schematically illustrates a scaled 3D digital model of a gingiva template, a second spline curve and its deformation anchor points in in one example, shown in one interface of the

FIG. 12A illustrates a 3D digital model of a gingiva template before performing 2D scaling on two ends in one example, shown in one interface of the computer program;

FIG. 12B illustrates a 3D digital model of a gingiva template obtained by performing 2D scaling on two ends on the 3D digital model of the gingiva template shown in FIG. 12A, shown in one interface of the computer program;

FIG. 13A illustrates a 3D digital model of a gingiva template and a 3D digital model of crowns before deformation process in one example, shown in one interface of the computer program;

FIG. 13B illustrates a 3D digital model of jaw obtained by combining the 3D digital model of the gingiva shown in FIG. 13A after deformation process and the 3D digital model of the crowns shown in FIG. 13A, shown in one interface of the computer program;

FIG. 13C illustrates the 3D digital model of the jaw shown in FIG. 13B after rendering, shown in one interface of the computer program;

FIG. 14 schematically illustrates a flow chart of a method for generating a 3D digital model of a tooth according to a further embodiment of the present application;

FIG. 15 illustrates a 3D digital model of a crown in one example shown in one interface of a computer program for generating a 3D digital model of a tooth according to one embodiment of the present application;

FIG. 16 illustrates 3D digital models of root templates of teeth Nos. 1-8 of upper jaw shown in one interface of the computer program;

FIG. 17A illustrates a 3D digital model of a crown and a scaled 3D digital model of a root template which are aligned in one example, shown in one interface of the computer program;

FIG. 17B illustrates a 3D digital model of root obtained by deforming the 3D digital model of the root template shown in FIG. 17A and the 3D digital model of the crown shown in FIG. 17A, shown in one interface of the computer program;

FIG. 17C illustrates a 3D digital model of a tooth by stitching the 3D digital model of the crown and the 3D digital model of the root shown in FIG. 17B, shown in one interface of the

FIG. 17D illustrates a 3D digital model of a tooth obtained by performing harmonic shape on a root region adjoining the crown of the 3D digital model of the tooth shown in FIG. 17C, shown in one interface of the computer program;

FIG. 18A illustrates 3D digital models of two adjacent teeth whose roots collide with each other in one example shown in one interface of the computer program; and

FIG. 18B illustrates the 3D digital models of two adjacent teeth shown in FIG. 18A after the collision is eliminated, shown in one interface of the computer program.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

One aspect of the present application provides a method of generating a 3D digital model of a jaw, which is able to generate a 3D digital model of a jaw of which gingiva changes with movements of teeth. The method of generating a 3D digital model of a jaw according to the present application will be described below by taking generation of a 3D digital model of a jaw used to make a shell-shaped tooth repositioner as an example.

An orthodontic treatment using shell-shaped tooth repositioners is to successively wear a series of successive shell-shaped tooth repositioners to reposition the patient's teeth from an initial tooth arrangement to a first intermediate tooth arrangement, a second intermediate tooth arrangement . . . a final intermediate tooth arrangement to a target tooth arrangement. A corresponding series of successive 3D digital models of the jaw need to be made to make the series of successive shell-shaped tooth repositioners.

Referring to FIG. 1, it schematically illustrates a flow chart of a method 100 for generating a 3D digital model of a jaw according to one embodiment of the present application.

In one embodiment, the method 100 for generating a 3D digital model of a jaw is implemented by a computer. Another aspect of the present application provides a computer system for generating a 3D digital model of a jaw, the system comprises a storage device and a processor, wherein the storage device stores a computer program which when executed will cause the processor to perform the method 100 for generating a 3D digital model of a jaw.

In 101, a 3D digital model of gingiva in a first state is obtained.

For ease of description, a 3D digital model of gingiva and a 3D digital model of crowns which match with each other are referred to as a 3D digital model of gingiva and a 3D digital model of crowns in the same state. For example, a 3D digital model of gingiva in a first state and a 3D digital model of crowns in a first state match with each other, a 3D digital model of gingiva in a second state and a 3D digital model of crowns in a second state match with each other, and so on. In practice, a 3D mesh model is the most commonly-used 3D digital model. Therefore, in the following depiction, in most cases, a 3D digital model is interchangeable with a 3D mesh model.

In one embodiment, a 3D mesh model of a jaw in an initial state may be obtained by intraoral scan or by scanning an impression or a physical model of the jaw. Then the crown part and the gingiva part are segmented to obtain a crown 3D mesh model and gingiva 3D mesh model in the initial state.

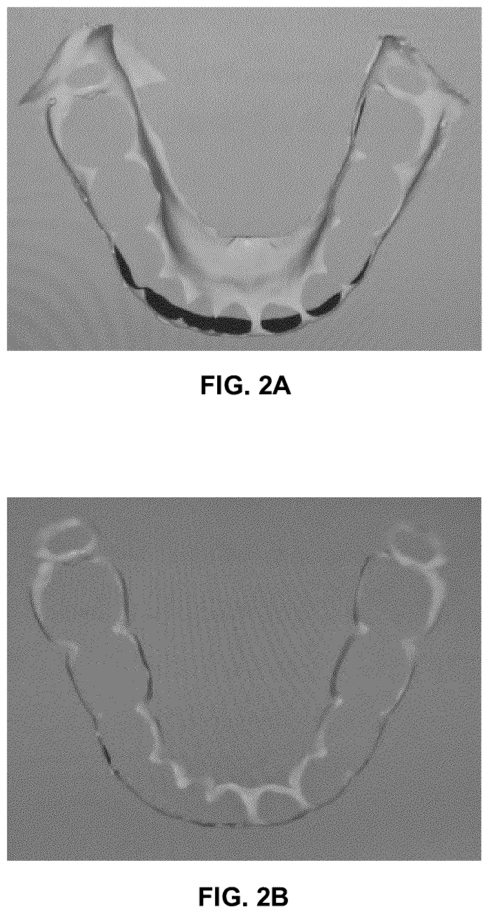

Referring to FIG. 2A, it illustrates one interface of a computer program for generating a 3D digital model of a jaw according to one embodiment of the present application, which interface shows a gingiva part after a crown part is removed from a 3D digital model of a jaw in an initial state, which is obtained by scanning.

The manufacture of a shell-shaped tooth repositioner does not require a 3D digital model of the whole gingiva, and furthermore, a part adjacent to the edge of the gingiva of a 3D digital model of a jaw obtained by scanning usually does not have ideal quality. Therefore, it can keep only the needed gingiva part. For example, as for the manufacture of a shell-shaped tooth repositioner, generally only the gingiva part 2 mm within the gingival line is needed. Referring to FIG. 2B, it illustrates a remaining part after an unnecessary part is removed from the 3D digital model of the gingiva shown in FIG. 2A, shown in one interface of the computer program.

A base having a certain height is also needed in addition to the crowns and the needed gingiva part on the jaw model for making the shell-shaped tooth repositioner using a thermoplastic forming technique. Therefore, a first-state gingiva 3D digital model comprising the needed gingiva part and the base may be generated. In one embodiment, the first-state gingiva 3D digital model may be generated using the following method.

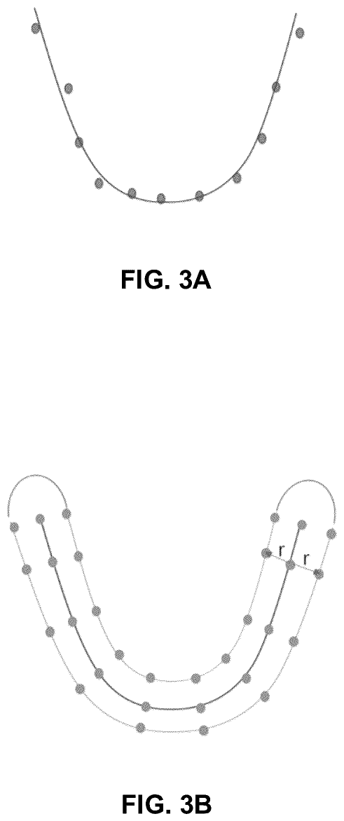

First, a geometrical central point of the boundary of each crown (the boundary between the crown and the gingiva) is identified (the coordinates of the geometrical central point of a crown may be calculated by averaging the coordinates of vertices on the boundary of the crown), and the geometrical central point is projected onto a plane on which the base bottom surface lies. Then, a first curve is fitted based on these projected points. Referring to FIG. 3A, it schematically illustrates projected points and a first curve fitted based on these projected points in one example.

Then, a predetermined number of sample points, e.g., 10 sample points, may be sampled evenly on the first curve. After that, these sample points are shifted by a predetermine distance r a normal direction of the first curve to obtain a first group of points, then the first group of points are taken as cubic spline curve control points, and an outer contour line of the base bottom surface is obtained by cubic spline curve interpolation. Then, the sample points are shifted by the predetermined distance r along a direction opposite to the normal direction of the first curve to obtain a second group of points, then the second group of points are taken as cubic spline curve control points, and an inner contour line of the base bottom surface is obtained by cubic spline curve interpolation. Lastly, ends of the inner and outer contour lines are connected to each other using a semi-circle having a radius r, to obtain a complete contour line of the base bottom surface. Referring to FIG. 3B, it illustrates a complete contour line of a base bottom surface in one example.

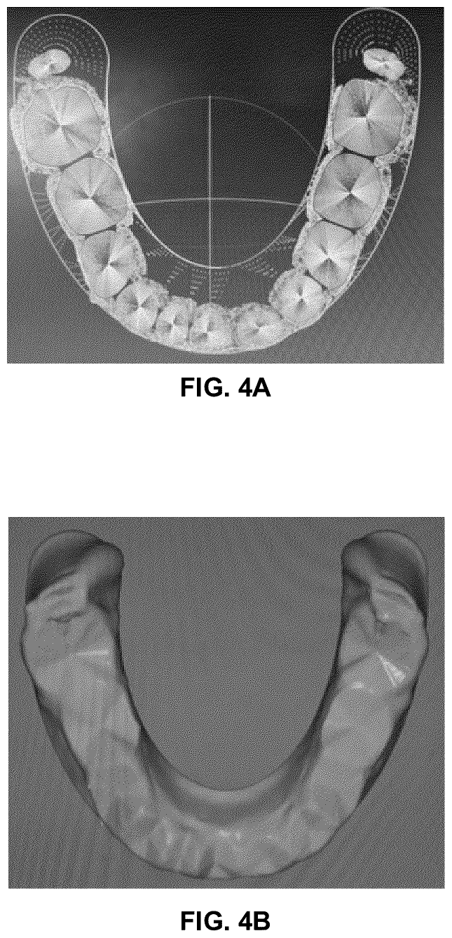

Then, points are interpolated within the openings of the crowns, the contour line of the base bottom surface, and between the gingiva and the contour line of the base bottom surface, then Poisson reconstruction is performed based on these interpolated points to generate a closed first-state gingiva 3D digital model comprising the needed gingiva part in the initial state and the base. Referring to FIG. 4A, it illustrates a point could based on which Poisson reconstruction is performed in one example, shown in one interface of the compute program. Referring to FIG. 4B, it illustrates a first-state gingiva 3D digital model which is obtained by Poisson construction based on the point cloud shown in FIG. 4A, shown in one interface of the computer program.

In some cases, the generated first-state gingiva 3D digital model might have some flaws comprising bubbles and unsmoothness of the edge line of the base bottom surface. Corresponding process may be performed to eliminate these flaws. In one embodiment, an Ambient Occlusion (AO) value may be calculated for each vertex. If the AO value is smaller than a predetermined threshold (e.g., 0.2), it is believed that there is a bubble here. The air bubbles are removed by Laplacian smoothing the vertex. Since these processing means are well known by those having ordinary skill in the art, they will not be described in detail any more here.

It is understood that the base part of the first-state gingiva 3D digital model may also be generated using other suitable methods in addition to the above method.

In 103, deformation control points are selected on the first-state gingiva 3D digital model.

In order to enable the gingiva part of the first-state gingiva 3D digital model to deform with movements of the crowns, a group of deformation control points need to be selected on the boundaries between the gingiva part of the first-state gingiva 3D digital model and the crowns.

In one embodiment, the deformation control points may be selected as follows: sampling control points at a predetermined interval on the contour line of the base bottom surface; as for each crown, evenly sampling a predetermined number of sample points (e.g., five sample points) respectively on both labial side and lingual side of a boundary of the crown as deformation control points; as for each crown, selecting one point on both sides along the dental arch curve on the boundary of the crown (i.e., a position adjacent to a neighboring tooth) as deformation control points; and as for each crown, selecting a center of gravity as deformation control point. In the initial state, the crowns completely match the gingiva. Therefore, at this time, the deformation control points on the crowns overlap corresponding deformation control points on the gingiva.

In 105, deformation process is performed on the first-state gingiva 3D digital model based on the deformation control points of the first-state gingiva 3D digital model and the deformation control points of a 3D digital model of the crowns in a second state, to obtain a second-state gingiva 3D digital model.

The deformation process may adopt any suitable deformation method for a mesh model, including but not limited to Thin-Plate Splines (TPS) deformation method, Laplace deformation method, and rigid body deformation method etc.

In one embodiment, TPS deformation method may be used to deformation process the first-state gingiva 3D digital model.

For specific implementation of the TPS deformation method, reference may be made to Principal Warps: Thin-Plate Splines and the Decomposition of Deformations published by Fred L. Bookstein in IEEE Transactions On Pattern Analysis and Machine Intelligence. Vol. 11, No.6, June 1989, and Thin-Plate Spline Approximation for Image Registration published by Rolf Sprengel, Karl Rohr and H. Siegfried Stiehl in Proceedings of 18th Annual International Conference of the IEEE Engineering in Medicine and Biology Society.

In one embodiment, the control points of the 3D digital model of the crowns in the second state may be taken as new positions of corresponding control points of the first-state gingiva 3D digital model, the control points on the contour line of the base bottom surface may be remained stationary. A TPS deformation equation may be established based on this, new coordinates of the vertices of the second-state gingiva 3D digital model may be calculated according to the deformation equation, and a second-state gingiva 3D digital model is reconstructed.

The 3D digital model of the crowns in the second state is different from the 3D digital model of the crowns in the first state in terms of pose of at least one crown. For example, the 3D digital model of the crowns in the second state may be a 3D digital model of the crowns under the target tooth arrangement of any repositioning step of an orthodontic treatment.

In the deformation process, the boundaries of crowns in the second-state, whose poses have not changed relative to the first-state, coincide with the corresponding boundaries of the first-state gingiva 3D digital model.

In 107, the second-state gingiva 3D digital model and the 3D digital model of the crowns in the second state are combined to obtain a 3D digital model of the jaw in the second state.

Corresponding deformation control points of the second-state gingiva 3D digital model obtained after the deformation process coincide with those of the 3D digital model, and the second-state gingiva 3D digital model and the 3D digital model of the crowns are combined to obtain the 3D digital model of the jaw in the second state.

The corresponding deformation control points of the second-state gingiva 3D digital model obtained after the deformation process coincide with those of the 3D digital model of the crowns in the second state. In one embodiment, the second-state gingiva 3D digital model and the second-state crown 3D digital model may be combined using Boolean operation to obtain the 3D digital model of the jaw in the second state.

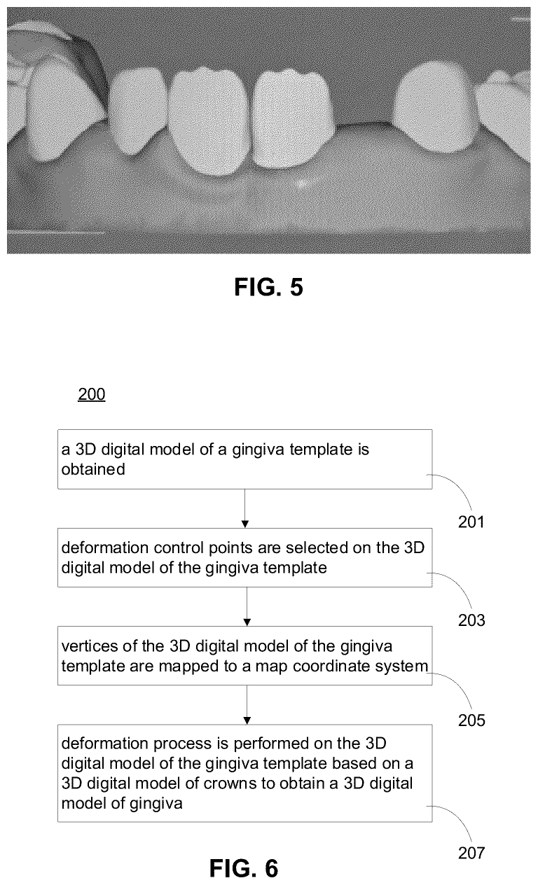

Referring to FIG. 5, it illustrates a 3D digital model of a jaw in the second state, obtained by the combination, shown in one interface of the computer program.

Another aspect of the present application provides a method for manufacturing a shell-shaped tooth repositioner. A series of successive 3D digital models of the jaw obtained by the above method are used to control an apparatus to make a series of successive positive models respectively, and a series of successive shell-shaped tooth repositioners are formed on the series of successive positive models using thermoplastic forming technique respectively. As compared with shell-shaped tooth repositioners made using conventional methods, the shell-shaped tooth repositioners made using the method according to the present application fit the gingiva more and is not prone to pressing the gingiva or non-fitting the gingiva, particularly the gingiva between two adjacent teeth.

Inspired by the present application, it is understood that in addition to 3D digital models of a jaw for making shell-shaped tooth repositioners, the method according to the present application can also be used to generate 3D digital models of a jaw for other purposes, for example, a 3D digital model of a jaw showing the result of an orthodontic treatment. It is understood that as for different applications, gingiva 3D digital models needed might be different from those in the above examples, for example, keep more real gingiva part or do not keep the base, etc.

A further aspect of the present application provides a method of generating a 3D digital model of a jaw. A deformation process is performed on a 3D digital model of a gingiva template according to a 3D digital model of crowns, and then, the 3D digital model of the crowns and the gingiva 3D digital model after the deformation process are combined to obtain a 3D digital model of a jaw. The method of generating a 3D digital model of a jaw according to one embodiment of the present application will be described below in detail with reference to figures.

Referring to FIG. 6, it schematically illustrates a flow chart of a method 200 for generating a 3D digital model of a jaw according to one embodiment of the present application.

In one embodiment, the method 200 for generating a 3D digital model of a jaw is implemented by a computer. Another aspect of the present application provides a computer system for generating a 3D digital model of a jaw, the system comprises a storage device and a processor, wherein the storage device stores a computer program which when executed will cause the processor to perform the method 200 for generating a 3D digital model of a jaw.

In 201, a 3D digital model of a gingiva template is obtained.

In one embodiment, a mesh model having basic geometry of the gingiva may be generated using CAD software and taken as the 3D digital model of the gingiva template. The number of vertices of the 3D digital model of the gingiva template may be determined according to specific needs. The larger the number of vertices, the more details of the model, and the slower the deformation process, vice versa.

In one embodiment, the model may be bilaterally symmetrical. Therefore, it is optional to only make either a left part or a right part of the model, and obtain the other half by mirroring.

In one embodiment, the upper and lower jaws may use the same basic template. In another embodiment, different templates may be made for the upper jaw and lower jaw, respectively (e.g., a thickness of the upper jaw template is greater than that of the lower jaw template).

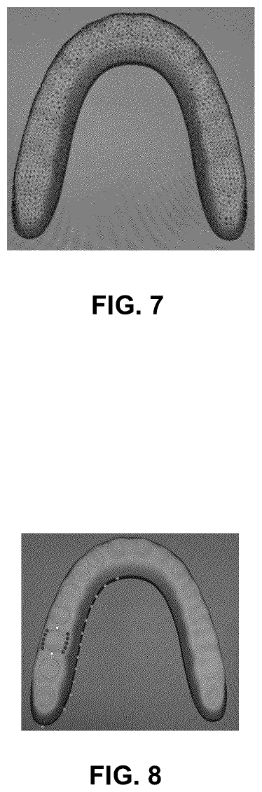

Referring to FIG. 7, it illustrates a 3D digital model of a gingiva template in one example shown in one interface of the computer program for generating a 3D digital model of a jaw according to one embodiment of the present application.

In 203, deformation control points are selected on the 3D digital model of the gingiva template.

After the 3D digital model of the gingiva template is obtained, some deformation control points needs to be selected thereon as anchor points for subsequent deformation process. Similarly, these deformation control points may be bilaterally symmetrical. Therefore, only the deformation control points on the left half or right half of the 3D digital model of the gingiva template need to be selected, and the deformation control points on the other half may be obtained by mirroring.

In one embodiment, the following points may be selected on the 3D digital model of the gingiva template as the deformation control points: (1) points on the edge of the bottom surface of the 3D digital model of the gingiva template, for example, the deformation control points may be sample evenly or at a predetermined interval; (2) points on boundaries where the gingiva and crowns joints, e.g., points on both the labial side and the lingual side on the boundaries, e.g., five points may be selected on each side; (3) points between adjacent teeth, e.g., a deformation control point is selected between every two adjacent crowns on the 3D digital model of the gingiva template.

Referring to FIG. 8, it illustrates partial deformation control points on a 3D digital model of a gingiva template in one example shown in one interface of the computer program.

In one embodiment, the deformation control points may be selected manually. In another embodiment, the deformation control points may also be selected automatically using a computer.

In 205, vertices of the 3D digital model of the gingiva template are mapped to a map coordinate system.

A texture map operation needs to be performed on the 3D digital model of the gingiva to color it to make its appearance closer to the real gingiva.

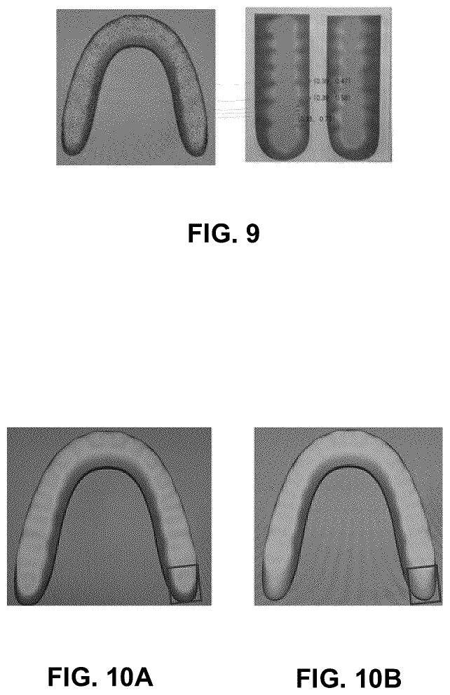

First, a texture map needs to be made. Referring to FIG. 9, it illustrates mapping of partial deformation control points on the 3D digital model gingiva template (on the left side) in one example shown in one interface of the computer program to a texture map (on the right side)

In one embodiment, positions (i.e., coordinates in the map coordinate system) of the deformation control points on the texture map may be marked manually.

In one embodiment, the texture map may be made manually using Photoshop software.

In one embodiment, after the coordinates of the deformation control points of the 3D digital model of the gingiva template in the map coordinate system are marked, the map coordinates of remaining vertices may be calculated using Harmonic Map algorithm. For details of Harmonic Map algorithm, reference may be made to Multiresolution Analysis of Arbitrary Meshes published in SIGGRAPH '95: Proceedings of the 22nd Annual Conference on Computer Graphics and Interactive Techniques, in September 1995.

After the coordinates of all vertices of the gingiva 3D digital model template in the map coordinate system are obtained, OpenGL can be used to render the map on the surface of the 3D digital model of the gingiva template or the 3D digital model of the gingiva obtained after the deformation process, to obtain the 3D digital model of the gingiva having an appearance similar to the real gingiva.

In 207, deformation process is performed on the 3D digital model of the gingiva template according to a 3D digital model of crowns, to obtain a 3D digital model of the gingiva.

After the 3D digital model of the crowns is obtained, the deformation process may be performed on the 3D digital model of the gingiva template according to the arrangement of the 3D digital model of the crowns, to obtain the gingiva 3D digital model that matches with the 3D digital model of the crowns. So, the 3D digital model of the crowns and the gingiva 3D digital model can be combined to obtain the 3D digital model of the jaw. In one embodiment, the 3D digital model of the crowns comprises a plurality of crowns.

In one embodiment, the 3D digital model of the crowns in the initial state may be obtained by intraoral scan or by scanning an impression or a physical model. A 3D digital model of the crowns having a different tooth arrangement may be obtained by manipulating the 3D digital model of the crowns in the initial state to move one or more crowns.

Each quadrant of the 3D digital model of the gingiva template has eight positions each of which forms a concave geometry that suites a corresponding crown. However, not in all cases that there are eight teeth in each quadrant. Therefore, the 3D digital model of the gingiva template needs to be modified to remove the concave geometries from redundant tooth positions. In a case where each quadrant only has seven teeth, in one embodiment, the excess part at the ends of the 3D digital model of the gingiva template may be processed calculated in terms of harmonic shape to change it into a round and smooth geometry which is contiguous with the non-end part. As such, the redundant tooth position geometries are removed.

In one embodiment, an algorithm of harmonic shape disclosed in An Intuitive Framework for Real-Time Freeform Modeling published by Mario Botsch and Leif Kobbelt in SIGGRAPH '04: ACM SIGGRAPH 2004 Papers, August 2004, Pages 630-634, may be used, particularly an energy equation (i.e., Thin Plate Surface) wherein k is 2-order.

Referring to FIG. 10A, it illustrates a 3D digital model of a gingiva template in one example shown in one interface of the computer program; then referring to FIG. 10B, it illustrates a 3D digital model of the gingiva template after one tooth position is respectively removed from both lateral ends of the 3D digital model of the gingiva template shown in FIG. 10A.

Then, a length and a width of the 3D digital model the crowns may be calculated, and scaling may be performed on the 3D digital model of the gingiva template to make the contour of the scaled 3D digital model the gingiva template substantially coincide with that of the 3D digital model of the crowns.

Then, the arch of the 3D digital model of the gingiva template may be changed according to the 3D digital model of the crowns. In one embodiment, a first spline curve may be fitted based on centers of tooth positions of the 3D digital model of the crowns, and a predetermined number of sample points (e.g., 10 sample points) may be sampled evenly thereon as deformation anchor points. Likewise, a second spline curve may be fitted based on centers of tooth positions of the 3D digital model of the gingiva template, and the same number of sample points may be sampled evenly thereon as deformation anchor points. Then, a 2D TPS deformation equation may be established based on the two sets of anchor points, and 2D TPS deformation process is performed on the scaled 3D digital model of the gingiva template and deformation control points, to make the arch of the 3D digital model of the gingiva template matches that of the 3D digital model of the crowns.

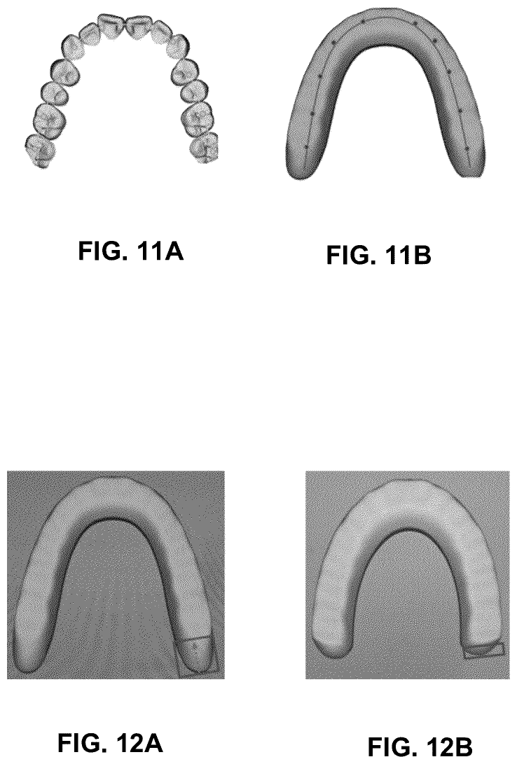

Referring to FIG. 11A, it illustrates a 3D digital model of crowns, a first spline curve and its deformation anchor points in in one example shown in one interface of the computer program. Referring to FIG. 11B, it illustrates a scaled 3D digital model of a gingiva template, a second spline curve and its deformation anchor points in in one example shown in one interface of the computer program.

Then, 2D scaling may be performed on the excess part on the ends of the arch-matched 3D model of the gingiva template. Referring to FIG. 12A, it illustrates a 3D digital model of a gingiva template before the 2D scaling on the ends in one example shown in one interface of the computer program. Referring to FIG. 12B, it illustrates a 3D digital model of the gingiva template obtained after performing 2D scaling on the ends of the 3D digital model of the gingiva template shown in FIG. 12A.

Then, the deformation control points may be selected on the 3D digital model of the crowns. In one embodiment, the deformation control points on the 3D digital model of the crowns may be selected as follows: (1) a predetermined number of deformation control points are selected on the labial side and lingual side of the boundary of each crown (the predetermined number is the same as the number of corresponding deformation control points on the 3D digital model of the gingiva template so that the deformation control points of the two are in a one-to-one correspondence relationship); (2) a middle point of a line connecting nearest points of the boundaries of every two neighboring teeth is selected, which corresponds to the deformation control point between the corresponding neighboring tooth positions on the 3D digital model of the gingiva template. A boundary of a crown is a contour line where the crown and the gingiva joints.

Then, the deformation control points of the 3D digital model of the crowns are taken as new positions of corresponding deformation control points of the 3D digital model of the gingiva template, the deformation control points on the contour of the bottom surface of the 3D digital the gingiva model template are remained stationary, a deformation equation is established based on this, and coordinates of the vertices of the 3D digital model of the gingiva are calculated to obtain the 3D digital model of the gingiva that matches with the 3D digital model of the crowns.

In one embodiment, in the deformation process on the 3D digital model of the gingiva template, relative position between the 3D digital model of the crowns and the 3D digital model of the gingiva template is determined based on an average value of z coordinates of center points of the boundaries of the crowns of the 3D digital model of the crowns and an average value of z coordinates of center points of the boundaries of the crowns of the 3D digital model of the gingiva template.

The deformation process may adopt any suitable deformation method for a mesh model, including but not limited to Thin-Plate Splines (TPS) deformation method, Laplace deformation method, and rigid body deformation method etc.

In one embodiment, the deformation process performed on the 3D digital model of the gingiva template may be based on TPS deformation method.

For specific implementation of TPS deformation method, reference may be made to Principal Warps: Thin-Plate Splines and the Decomposition of Deformations published by Fred L. Bookstein in IEEE Transactions On Pattern Analysis and Machine Intelligence. Vol. 11, No.6, June 1989, and Thin-Plate Spline Approximation for Image Registration published by Rolf Sprengel, Karl Rohr and H. Siegfried Stiehl in Proceedings of 18th Annual International Conference of the IEEE Engineering in Medicine and Biology Society.

Corresponding deformation control points of the 3D digital model of the gingiva obtained after the deformation process coincide with those of the 3D digital model of the crowns. In one embodiment, the 3D digital model and the crown 3D digital model may be fused using Boolean operation to obtain the 3D digital model of a complete jaw.

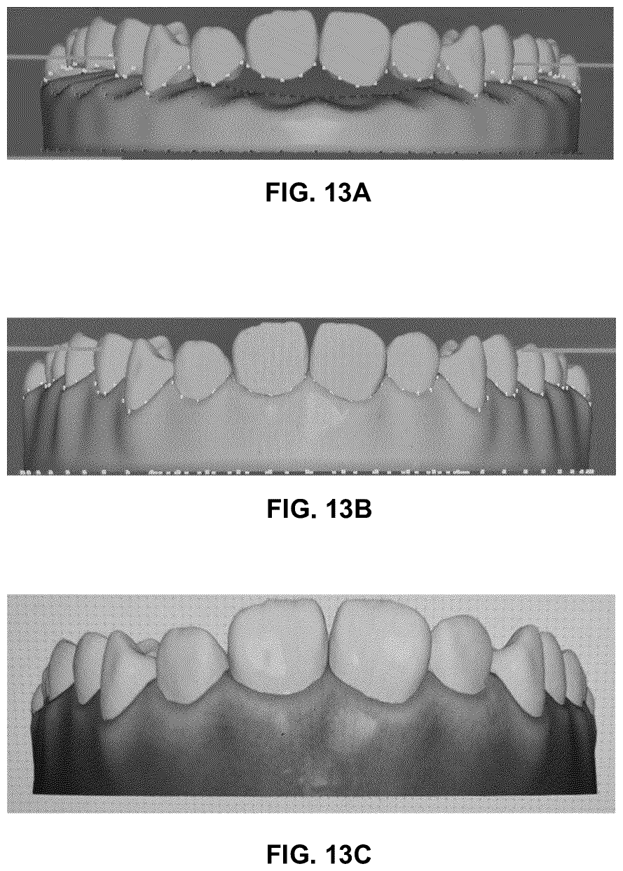

Referring to FIG. 13A, it illustrates a 3D digital model of a gingiva template and a 3D digital model of crowns before deformation process in one example shown in one interface of the computer program. Referring to FIG. 13B, it illustrates a 3D digital model of a jaw obtained by fusing a 3D digital model of gingiva obtained by deforming the 3D digital model of the gingiva template shown in FIG. 13A and the 3D digital model of the crowns shown in one interface of the computer program.

Since the vertices on the 3D digital model of the gingiva template have been mapped to the map coordinate system previously, OpenGL may be used to render the texture map on the surface of the 3D digital model of the gingiva, to obtain a 3D digital model approximate to the real gingiva.

Referring to FIG. 13C, it illustrates the 3D digital model of the jaw shown in FIG. 13B after rendering shown in one interface of the computer program.

It is understood that only step 207 other than the steps 201-205 needs to be repeated in order to generate 3D digital models of the gingiva that match different 3D digital models of the crowns.

The manufacture of a shell-shaped tooth repositioner is taken as an example. An orthodontic treatment using shell-shaped tooth repositioners is to successively wear a series of successive shell-shaped tooth repositioners to reposition a patient's teeth from an initial tooth arrangement to a first intermediate tooth arrangement, a second intermediate tooth arrangement . . . . a final intermediate tooth arrangement to a target tooth arrangement. Firstly, a series of successive 3D digital models of crowns which represent a series of successive tooth arrangements, respectively, are obtained. Then, 207 is repeated to generate for each of the 3D digital models of the crows a 3D digital model of the gingiva that matches with it. Then, the 3D digital models of the crowns are fused with matching 3D digital models of the gingiva respectively to obtain 3D digital models of the jaw. Then, these 3D digital models of the jaw are used to control an apparatus to make positive models, and a series of successive shell-shaped repositioners are formed on the positive models respectively using thermoplastic forming technique.

A further aspect of the present application provides a method of generating a tooth 3D digital model, it comprises: substantially aligning a 3D digital model of a root template and a crown 3D digital model by translating, rotating and scaling, then performing deformation process on the 3D digital model of the root template to such that its boundary matches that of the crown 3D digital model, and fusing the crown 3D digital model with the deformed 3D digital model of the root to obtain a closed complete tooth 3D digital model. The method for generating a tooth 3D digital model according to one embodiment of the present application will be described in details with reference to figures.

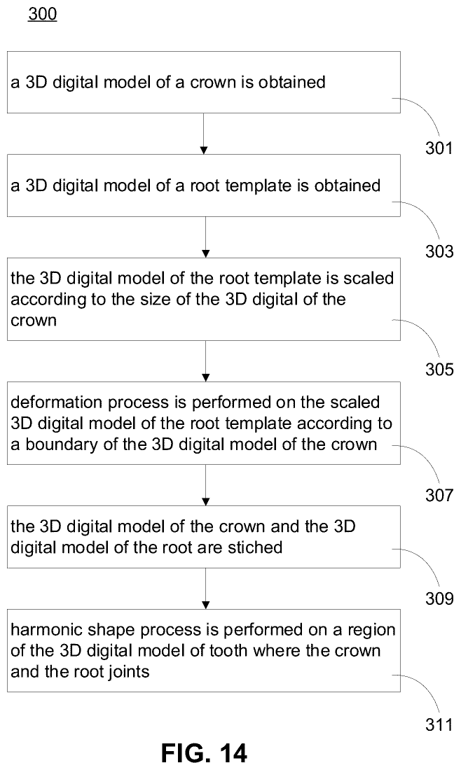

Referring to FIG. 14, it schematically illustrates a flow chart of a method for generating a tooth 3D digital model according to one embodiment of the present application.

In 301, a crown 3D digital model is obtained.

In one embodiment, the crown 3D digital model may be obtained by intraoral scan or by scanning an impression or a physical model of teeth. Usually, a 3D digital model of a whole dentition (i.e., the upper jaw dentition or lower jaw dentition) obtained by scanning are segmented into 3D digital models of individual teeth.

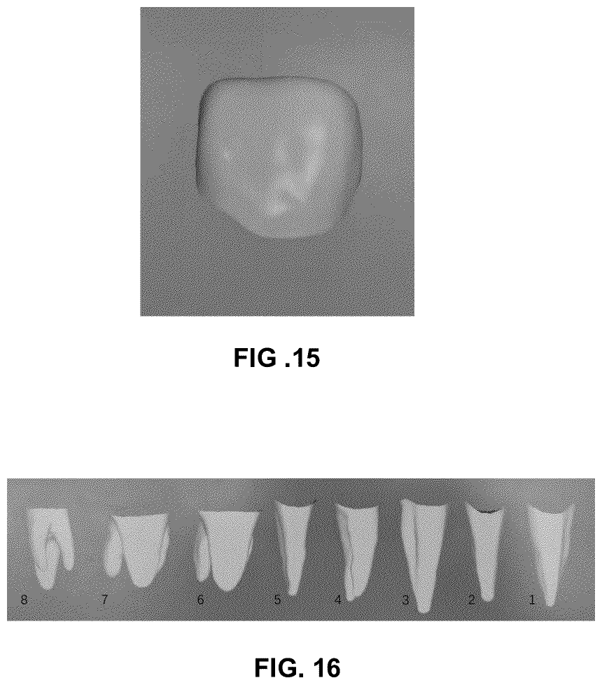

Referring to FIG. 15, it illustrates a crown 3D digital model in one example shown in one interface of a computer program for generating a tooth 3D digital model according to one embodiment of the present application.

In 303, a 3D digital model of a root template is obtained.

In one embodiment, a large number of real roots are scanned by Cone Beam Computed Tomography (hereinafter referred to as CBCT) to obtain corresponding root 3D digital models, and then the root 3D digital models of corresponding-numbered teeth are averaged to obtain 3D digital models of root templates of the correspondingly-numbered teeth.

In a case that there is no missing tooth, each of the upper jaw dentition and lower jaw dentition has 16 teeth; since the teeth are bilaterally symmetrical, only eight 3D digital models of root templates need to be established for each of the upper jaw and lower jaw.

Referring to FIG. 16, it illustrates 3D digital models of root templates of teeth No. 1-8 of an upper jaw dentition in one example shown in one interface of the computer program.

A corresponding 3D digital model of a root template is selected according to the tooth number of the crown, to generate a complete tooth 3D digital model.

In 305, the 3D digital model of the root template is scaled according to the size of the crown 3D digital model.

In some cases, the size of the 3D digital model of the root template does not certainly match that of the crown. In such case, the 3D digital model of the root template may be scaled such that its size matches that of the crown to ensure a natural geometry of the subsequently generated complete tooth 3D digital model.

In one embodiment, a scaling factor may be determined by the following method: projecting the boundary of the crown onto an XY plane, and calculating a length of a diagonal line of a bonding box, similarly projecting the boundary of the root onto an XY plane, and calculating a length of a diagonal line of a bonding box, and a ratio obtained by dividing the length of the diagonal line of the bonding box of the projected crown by the length of the diagonal line of the bonding box of the projected root as the 3D scaling factor of the root.

In one embodiment, before the 3D digital model the root template is scaled, it may be aligned with the crown 3D digital model by translating and rotating so that the 3D digital model of the root template and the crown 3D digital model have parallel long axes and the same mesial-distal direction from a proximal end to a distal end, and the centers of their boundaries substantially coincide.

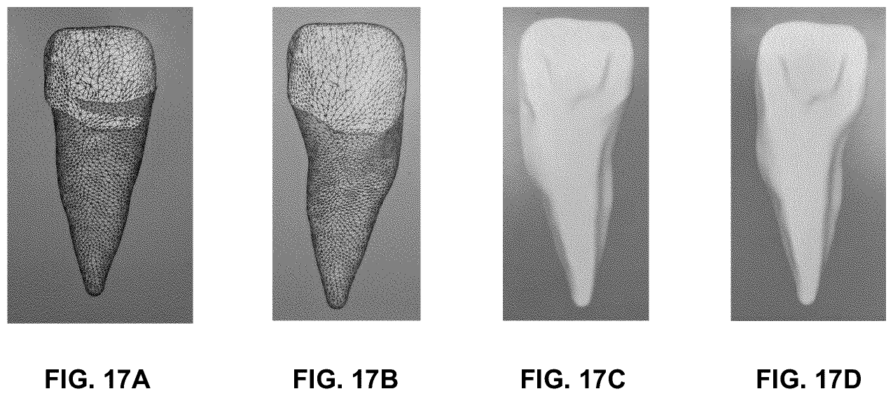

Referring to FIG. 17A, it illustrates a crown 3D digital model and a scaled 3D digital model of a root template that are aligned in one example shown in one interface of the computer program.

In 307, deformation process is performed on the scaled 3D digital model of the root template based the boundary of the crown 3D digital model.

In one embodiment, a plurality of deformation control points may be selected on the edge (i.e., the boundaryl) of the crown 3D digital model, corresponding deformation control points may be selected on the edge of the scaled 3D digital model of the root template, then the deformation control points of the crown 3D digital model may be taken as new positions of corresponding deformation control points of the 3D digital model of the root template, a deformation equation may be established based on this, and deformation process may be performed on the 3D digital model of the root template to obtain the root 3D digital model that matches the crown 3D digital model.

In one embodiment, the deformation control points on the crown 3D digital model and the 3D digital model of the root template may be selected in this way: N (e.g., 30) points are evenly sampled on the edge of the crown 3D digital model as the deformation control points of the crown 3D digital model, and accordingly, N points are evenly sampled on the edge of the 3D digital model of the root template as the deformation control points of the 3D digital model of the root template.

The deformation process may adopt any suitable deformation method for a mesh model, including but not limited to Thin-Plate Splines (TPS) deformation method, Laplace deformation method, and rigid body deformation method etc.

In one embodiment, the deformation process using TPS deformation method may be performed on the first-state gingiva 3D digital model.

For specific implementation of TPS deformation method, reference may be made to Principal Warps: Thin-Plate Splines and the Decomposition of Deformations published by Fred L. Bookstein in IEEE Transactions On Pattern Analysis and Machine Intelligence. Vol.11, No.6, June 1989, and Thin-Plate Spline Approximation for Image Registration published by Rolf Sprengel, Karl Rohr and H. Siegfried Stiehl in Proceedings of 18th Annual International Conference of the IEEE Engineering in Medicine and Biology Society.

Referring to FIG. 17B, it illustrates a root 3D digital model obtained by deforming the root 3D digital model shown in FIG. 17A and the crown 3D digital model shown in FIG. 17A, shown in one interface of the computer program.

In 309, the crown 3D digital model and the root 3D digital model are stitched.

Although the edge of the root 3D digital model obtained after the deformation process substantially coincide with the edge of the crown 3D digital model, other points other than the deformation control points on the edges of the two models might not coincide. Therefore, the two models may be stitched in a manner of stitching mesh models, to obtain a complete and closed tooth 3D digital model.

Referring to FIG. 17C, it illustrates a tooth 3D digital model obtained by stitching the crown 3D digital model and root 3D digital model shown in FIG. 17B shown in one interface of the computer program.

In 311, harmonic shape is performed on a region where the root joints the crown in the tooth 3D digital model.

To make the joint between the root and crown of the tooth 3D digital model more natural, in one embodiment, harmonic shape may be performed on the region where the root joints the crown. In one embodiment, harmonic shape may be performed on a region within a predetermined distance below the edge of the crown, for example, a region within 2 mm below the edge of the crown. It is understood that the predetermined distance may be determined according to specific needs and situations.

In one embodiment, the algorithm of harmonic shape may be the algorithm disclosed in An Intuitive Framework for Real-Time Freeform Modeling published by Mario Botsch and Leif Kobbelt in SIGGRAPH '04: ACM SIGGRAPH 2004 Papers, particularly an energy equation (i.e., Thin Plate Surface) where k is 2-order.

Referring to FIG. 17D, it illustrates a tooth 3D digital model obtained after performing harmonic shape on part of a root region that joints the crown in the tooth 3D digital model shown in FIG. 17C, shown in one interface of the computer program.

The above method 300 for generating a tooth 3D digital model is for generating a 3D digital model of a single tooth. After 3D digital models of a plurality of teeth of a dentition are generated using the method, the roots of adjacent tooth 3D digital models might collide with each other. In this case, process may be performed on the colliding roots to eliminate the collisions. In one embodiment, the method 300 for generating a tooth 3D digital model may further comprise a collision elimination operation. In one embodiment, the collision between roots may be eliminated using the following method.

As for each pair of neighboring teeth, first, whether there is collision between them is detected; if YES, a maximum collision depth therebetween is calculated, and the collision is classified according to the maximum collision depth and a predetermined threshold into a moderate collision (i.e., the maximum collision depth is smaller than the threshold) or a deep collision (i.e., the maximum collision depth is greater than the threshold).

For a moderate collision, all collision points and their neighboring points (e.g., first-order neighboring points or second-order neighboring points) are found, and then, each of these points is moved in a direction opposite to its normal direction by a certain distance (the distance is determined according to the collision depth, e.g., 0.6 times the collision depth). Finally, a harmonic shape and smoothing operations are performed on all the involved points.

For a deep collision, points to be moved on the roots are determined according to a height of the deepest collision point. In one embodiment, a root may be divided along a height direction into a root neck region, a root middle region and a root tip region, the height of each region is ⅓ of the total height. The points to be moved may be identified within the root tip region according to a proportion of a vertical distance from the deepest collision point to the root tip and the total height of the root (in the embodiment, only points in the root tip region are selected as points to be moved). For example, when the proportion is ⅕, all points within the ⅕ region at the bottom of the root tip are points to be moved, other points in the root tip region and points in the root middle region and root neck region are following points, and points on the crown are stationary points. That is to say, the farther the distance of the deepest collision point from the root tip, more points need to be moved. Lastly, a movement distance of the points to be moved may be determined according to the collision depth of the deepest collision point (e.g., the movement distance may be the maximum collision depth); a displacement direction of the points to be moved may be determined according to the position of the deepest collision point (e.g., the displacement direction may be a direction of a line connecting the deepest collision point), and an operation such as mesh deformation (e.g., Laplace deformation) may be performed on the mesh.

After the above operation, complete elimination of collision cannot be ensured because there might a case in which collision changes from deep collision to moderate collision, or a new collision might occur. Therefore, iterative operation may be performed until all collision is eliminated.

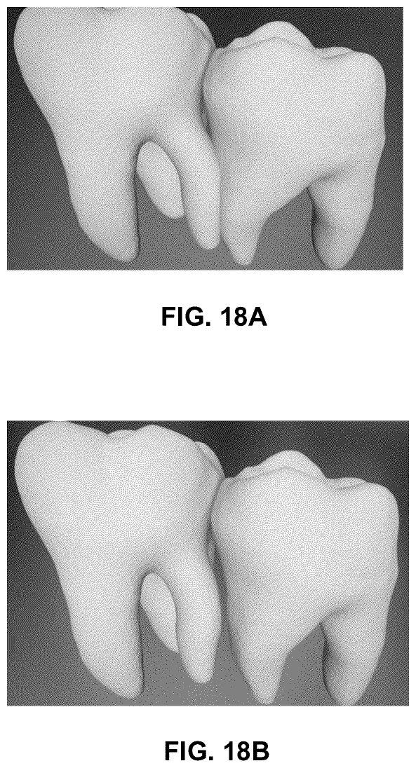

Referring to FIG. 18A, it illustrates a 3D digital model of two adjacent teeth whose roots collide with each other in one example shown in one interface of the computer program.

Referring to FIG. 18B, it illustrates a 3D digital model of two adjacent teeth obtained by eliminating collision of the 3D digital model of two adjacent teeth shown in FIG. 18A, shown in one interface of the computer program.

In one embodiment, all operations of the above method may be implemented by a computer.

A further aspect of the present application provides a computer system for generating a jaw 3D digital model, the system comprising a storage device and a processor, wherein the storage device stores a computer program which when executed will cause the processor to perform the method 300 for generating a tooth 3D digital model.

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

1. A computer-implemented method for generating a 3D digital model of gingiva, comprising:
obtaining a 3D digital model of gingiva in a first state; and
performing deformation process on the 3D digital model of the gingiva in the first state based on its deformation control points and deformation control points of a 3D digital model of crowns in a second state, to obtain a 3D digital model of the gingiva in the second state,
wherein corresponding deformation control points of 3D digital models of the crowns and the gingiva in the same state coincide.

2. The computer-implemented method for generating a 3D digital model of gingiva of claim 1, wherein in the deformation process, the deformation control points of the 3D digital model of the crowns in the second state are taken as new positions of corresponding deformation control points of the 3D digital model of the gingiva in the first state, a deformation equation is established based on this, and coordinates of vertices of the 3D digital model of the gingiva in the second state.

3. The computer-implemented method for generating a 3D digital model of gingiva of claim 2, wherein the deformation control points of the 3D digital model of the gingiva in the first state comprise deformation control points on boundaries of the crowns, the deformation control points of the 3D digital model of the crowns comprise deformation control points on the boundaries of the crowns, and the deformation control points on the boundaries of the crowns of the 3D digital model of the gingiva in the first state correspond to those of the 3D digital model of the crowns, respectively.

4. The computer-implemented method for generating a 3D digital model of gingiva of claim 3, wherein the deformation control points of the 3D digital model of the gingiva in the first state further comprise deformation control points on the edge of its bottom surface, and these deformation control points remain stationary in the deformation process.

5. The computer-implemented method for generating a 3D digital model of gingiva of claim 1, wherein the deformation process is based on TPS deformation method.

6. The computer-implemented method for generating a 3D digital model of gingiva of claim 1, wherein the first state is an initial state.

7. The computer-implemented method for generating a 3D digital model of gingiva of claim 6, wherein the deformation control points are obtained by sampling on a 3D digital model of a jaw in the initial state.

8. The computer-implemented method for generating a 3D digital model of gingiva of claim 7, wherein the deformation control points are obtained by sampling evenly, and the number of the deformation control points is predetermined.

9. The computer-implemented method for generating a 3D digital model of gingiva of claim 7, wherein the 3D digital model of the jaw in the initial state is obtained by scanning one of the following: a patient's jaw, an impression of the patient's jaw and a physical model of the patient's jaw.

10. The computer-implemented method for generating a 3D digital model of gingiva of claim 6, wherein the 3D digital model of the gingiva in the first state comprises a real gingiva part and a base, where the real gingiva part joints the crowns and is located on the base.

11. The computer-implemented method for generating a 3D digital model of gingiva of claim 10, wherein the real gingiva part is a gingiva part within a predetermined distance from a gingival line.

12. The computer-implemented method for generating a 3D digital model of gingiva of claim 1, wherein the first state is the initial state, and the method further comprises:
obtaining a plurality of 3D digital models of the crowns in successive states; and
repeating the above operation to generate a plurality of 3D digital models of the gingiva in the successive states, each of which is generated based on the 3D digital model of the gingiva in the first state and a corresponding one in the plurality of 3D digital models of the crowns in the successive states.

13. A method for generating a jaw 3D digital model, comprising:
fusing the 3D digital model of the gingiva in the second state generated by the method for generating a 3D digital model of gingiva according to claim 1 and the 3D digital model of the crowns in the second state, to obtain a 3D digital model of a jaw in the second state.

14. A method for making a shell-shaped tooth repositioner, comprising:
using the 3D digital model of the jaw in the second state, generated by the method for generating a 3D digital model of a jaw according to claim 13, to control an apparatus to make a shell-shaped tooth repositioner.

15. A computer system for generating a 3D digital model of gingiva, comprising a storage device and a processor, wherein the storage device stores a computer program which when executed will cause the processor to perform the method for producing a 3D digital model of gingiva according to claim 1.

16-44. (canceled)
